(19) United States
(12) Patent Application Publication
(10) Pub. No.: US 2006/0174201 A1
(43) Pub. Date: Aug. 3, 2006

(54) Strategies for alerting users to events that have transpired in their absence

(75) Inventors: Melora Zaner-Godsey, Seattle, WA (US); Tammy L. Savage, Seattle, WA (US); Wende E. Copfer, Bothell, WA (US)

Correspondence Address: LEE & HAYES PLLC, 421 W RIVERSIDE AVENUE SUITE 500, SPOKANE, WA, 99201, US

(73) Assignee: Microsoft Corporation, Redmond, WA (US)

(21) Appl. No.: 11/048,112

(22) Filed: Feb. 1, 2005

(51) Int. Cl. G06F 17/00; G06F 15/173

(52) U.S. Cl. 715/736; 709/224

(57) ABSTRACT

While You Were Away (WYWA) functionality is described for alerting a user to events which have transpired between a time that the user ceases interaction with an electronic environment and a time that the user resumes interaction with the electronic environment. The detected events may include news stories, Email messages, offline instant messenger (IM) messages, and so forth. The WYWA functionality can order the events based on at least one ordering criterion, as well as group the events into multiple categories. The WYWA functionality displays the events in a user interface panel that is presented to the user upon the resumption of their use of the electronic environment. The user interface panel can include another section which displays information that is tailored to the user's geographic location and/or personal identity, another section which displays targeted advertising information, and another section that presents application-related features provided by an entity that sponsors the user interface panel, etc.

### TECHNICAL FIELD

This subject matter relates to strategies for alerting users to events. In a more particular implementation, this subject matter relates to strategies for alerting users to events that having transpired in the context of a standalone or online computer environment.

### BACKGROUND

The use of introductory user interface presentations (e.g., home pages) is ubiquitous in the computer arts. In a standalone computer environment, local functionality will typically present an initial startup presentation when a user initiates a session with a local application. In an online computer environment, local and/or remote functionality will similarly present an initial startup presentation when the user begins using an online application. Such startup presentations typically provide introductory or high-level information regarding the application, and may also provide a portal through which the user can initiate different services offered by the application.

Consider, for example, the MSN network introductory page provided by Microsoft Corporation of Redmond, Washington. One version of this introductory presentation currently includes an agglomeration of different parts, including one part that alerts the user to news, another part which provides financial information, another part which alerts the user to products or services provided by Microsoft Corporation, another part which provides a menu-type portal to individual services provided by the MSN network, another part which provides advertising information, and so forth.

There is considerable room for improvement in the above kinds of introductory presentations. One general disadvantage of these types of presentations is that they often fail to actively engage the user. This may be due to the fact that these presentations present too much information to the user, much of which is not tailored to their immediate needs. As a consequence, the user may have difficulty picking out information that may be of interest to him or her. Or the user may come to view the initial presentation as simply another unsolicited pop-up presentation, and therefore quickly dismiss its contents.

This lack of engagement is undesirable from both the standpoint of the provider and from the standpoint of the recipient of services. From the provider's standpoint, the user may fail to take note of advertising or other promoted features in the introductory presentation content, which may equate to loss of revenue for the provider. From the standpoint of the user, the user may become frustrated with the introductory presentation content due to its perceived complexity and failure to meet the user's needs.

For at least the above-identified reasons, there is an exemplary need for more satisfactory strategies for presenting introductory information to users upon their initiation of an application.

### SUMMARY

According to one exemplary implementation, a method is described alerting a user to events. The method comprises:
(a) detecting when the user ceases interaction with an electronic environment;
(b) detecting and retaining events which transpire after the user ceases interaction with the electronic environment to provide detected events, providing that the events that meet at least one criterion;
(d) detecting when the user resumes interaction with the electronic environment; and
(e) alerting the user, upon their resumption of interaction, to the detected events which have transpired between the time that the user ceases interaction with the electronic environment and resumes interaction with the electronic environment.

Additional exemplary implementations are described in the following.

### BRIEF DESCRIPTION OF THE DRAWINGS

FIG. 1 shows an exemplary overview of a While You Were Away (WYWA) concept.

FIG. 2 shows exemplary WYWA functionality for alerting users to events that have transpired in their absence (e.g., while they were offline).

FIG. 3 shows an exemplary system that can be used to implement the WYWA functionality of FIG. 2.

FIG. 4 shows an exemplary user interface presentation that can be produced by the A functionality of FIG. 2.

FIGS. 5 and 6 show two flowcharts which set forth exemplary procedural aspects of the WYWA functionality of FIG. 1.

FIG. 7 shows an exemplary computer environment for implementing aspects of the WYWA functionality of FIG. 1.

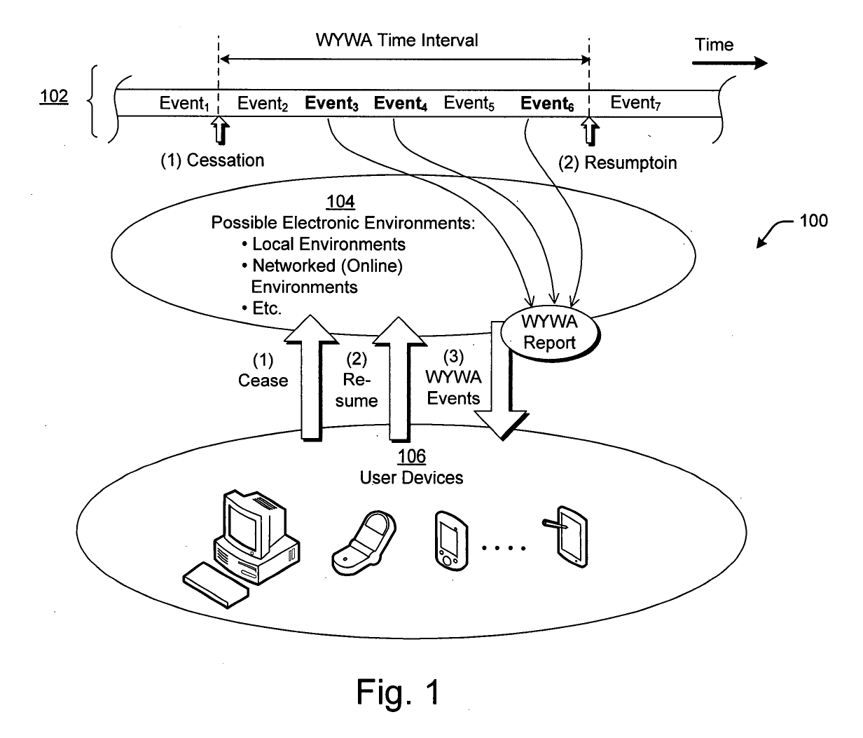

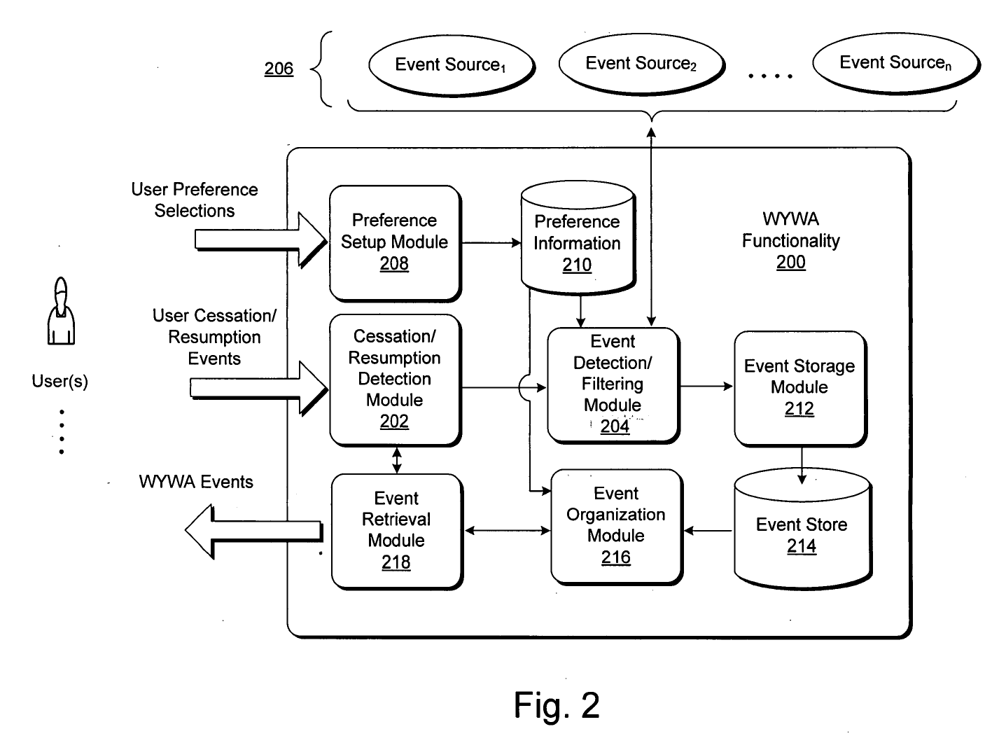

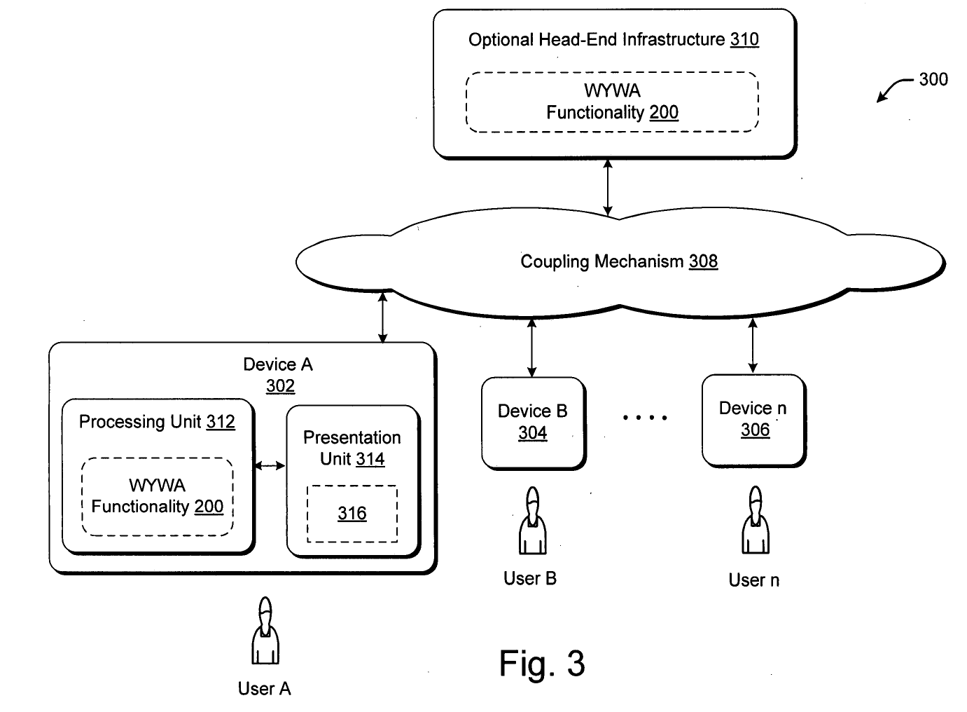

The same numbers are used throughout the disclosure and figures to reference like components and features. Series 100 numbers refer to features originally found in FIG. 1, series 200 numbers refer to features originally found in FIG. 2, series 300 numbers refer to features originally found in FIG. 3, and so on.

### DETAILED DESCRIPTION

The following description sets forth While You Were Away (WYWA) functionality for presenting a more engaging user interface presentation to the user when they begin to interact with an electronic environment. The WYWA functionality determines when the user has ceased interaction with the electronic environment and then when the user subsequently resumes use of the electronic environment. The WYWA functionality determines events that have transpired in the period that user was not actively engaged with the electronic environment. Such events may correspond to a wide variety of occurrences that can originate from different sources. Exemplary events may include news stories, Email messages, offline instant messenger (IM) messages, and so forth.

When the user resumes use of the electronic environment, the WYWA functionality provides a user interface presentation that alerts the user to the events that were detected during their absence. The WYWA functionality can order the events based on different factors. Also, the WYWA functionality can group the events into different categories and present the events in these groups for the user's review. The user interface presentation can integrate other display sections with the event information, including a display section that provides information tailored to the user's geographic area (e.g., weather information), another display section which provides targeted advertisements, another display section which promotes application-related features provided by the entity which sponsors the user interface presentation, and so forth.

The WYWA functionality confers a number of benefits. According to one benefit, the WYWA functionality provides a highly focused and user-specific collection of information that the user is likely to be interested in - that is, by quickly alerting the user to exactly what they missed “while away.” This has the potential of improving the user's level of engagement with the user interface presentation, thus potentially increasing the revenue of the provider of the presentation as well as providing a more valuable and enjoyable experience for the user.

Additional features and attendant benefits of the strategies will be set forth in this description.

As to terminology, the term “electronic environment” as used herein refers to any application or bundle of applications. In a standalone case, the electronic environment may correspond to the general collection of services provided by an electronic device; in other words, a user engages with that environment simply by being logged onto the electronic device or otherwise having active access to the electronic device. Alternatively, the electronic environment may correspond to a particular service or services offered by the electronic device. In a network (online) case, the electronic environment may correspond a network environment in general; in other words, the user interacts with such an environment simply by being actively engaged with the network environment (e.g., by being logged onto the network environment). Alternatively, the electronic environment may correspond to a particular service or services offered by the network environment.

The term “event” refers to any occurrence within the electronic environment. An event may correspond to a news story that was posted, a finance-related update, a received Email message, a received offline instant messenger (IM) message, any kind of alert message, and so forth. There are no restrictions placed on the nature of an event; different technical and business environments will define the term “event” to suit the respective needs of those environments.

The phrase “cease interaction” (and the equivalent) refers broadly to any event by which the user becomes inactive with respect to an electronic environment. In one scenario, a user ceases interaction with the electronic environment when the user enters a formal command to terminate interaction with the electronic environment (such as a formal shutdown command, a logoff command, a lock command, and so forth). In another scenario, the user ceases interaction with the electronic environment by simply ceasing engagement with the electronic environment, even though the electronic environment may otherwise remain enabled. For instance, the user can be considered as having ceased interaction with the electronic environment when it is detected that the user has failed to interact with the electronic environment for a predetermined period of time (e.g., 10 minutes), or when it is detected that the user has begun interacting with another electronic environment (e.g., where the user navigates to a second application program presented in a second UI pane from a first application program presented in a first UI pane), and so forth. Still other connotations of the phase “cease interaction” are envisioned. The phrase “resume interaction” is intended to have a complementary meaning to “cease interaction,” having similarly broad connotation.

The acronym WYWA (While You Were Away) serves simply as a shorthand reference to any functionality which culls events in the user's absence to present to the user upon their return. The use of this self-defined acronym carries no further connotation.

This disclosure includes the following sections. Section A presents exemplary systems for alerting a user to events that have transpired in the user's absence. Section B presents an exemplary user interface presentation that can be used in conjunction with the systems of Section A. Section C presents two flowcharts which describe the operation of the systems of Section A. Section D describes an exemplary computer environment for implementing aspects of the systems of Section A.

A. Exemplary Systems (FIGS. 1-3)

Generally, any of the functions described with reference to the figures can be implemented using software, hardware (e.g., fixed logic circuitry), manual processing, or a combination of these implementations. The term “logic”, “module” or “functionality” as used herein generally represents software, hardware, or a combination of software and hardware. For instance, in the case of a software implementation, the term “logic,” “module,” or “functionality” represents program code that performs specified tasks when executed on a processing device or devices (e.g., CPU or CPUs). The program code can be stored in one or more computer readable memory devices. More generally, the illustrated separation of logic, modules and functionality into distinct units may reflect an actual physical grouping and allocation of such software and/or hardware, or can correspond to a conceptual allocation of different tasks performed by a single software program and/or hardware unit. The illustrated logic, modules and functionality can be located at a single site (e.g., as implemented by a processing device), or can be distributed over plural locations.

A.1. Overview of the While You Were Away Concept

FIG. 1 shows an overview 100 of the While You Were Away concept. The purpose of the While You Were Away is to detect events that have transpired between the time that a user has ceased interacting with an electronic environment and the time that the user later resumes interacting with the electronic environment, and then to alert the user to those events when the user resumes interaction with electronic environment. FIG. 1 provides a timeline 102 that illustrates this notion. The timeline 102 shows a cessation occurrence (1) and a resumption occurrence (2). Between these two occurrences, a plurality of events (Event₂-Event₆) has transpired within the electronic environment being monitored. The purpose of the WYWA functionality is to present a subset of those events to the user when the user resumes interaction with the electronic environment. FIG. 1 illustrates the presentation of WYWA information to the user as action (3).

The WYWA functionality can select the subset of events based on various criteria. For instance, the WYWA functionality may sift through a vast number of events to detect events of a certain nature, such as headline news emanating from a certain network source, Emails transmitted to the user, and so forth. In the illustrative context of FIG. 1, the WYWA functionality has selected a subset of events comprising Event₃, Event₄ and Event₆. It will be appreciated that the number of events will typically be much greater than the amount illustrated in the exemplary case of FIG. 1.

In another variation, the WYWA functionality can place cap the events that it collects at a predetermined maximum amount of time, such as 48 hours. For instance, if a user takes a two week vacation, they may not want to be deluged with a large number of events. Limiting the time period over which events are collected can remedy this concern. The user can set preference information which defines whether such a time constraint is enabled, and if so, the maximum interval over which events are to be collected.

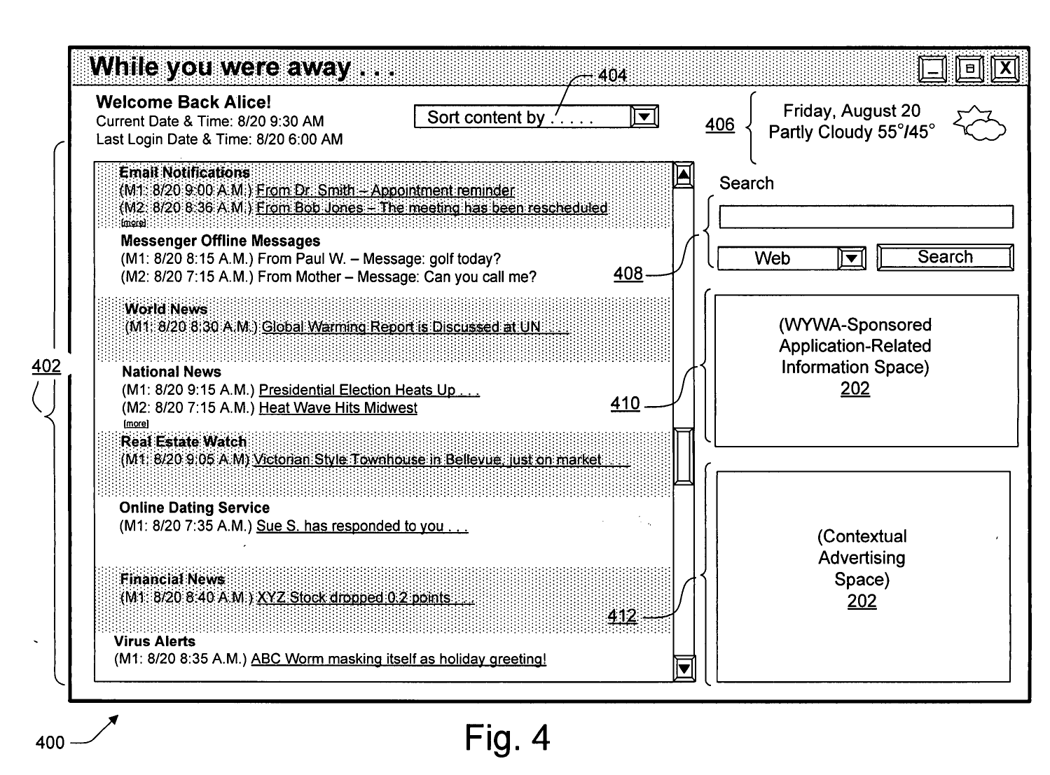

The WYWA functionality can present the subset of events to the user in a graphical user interface presentation, or in some other format. The WYWA functionality can order the events based on various criteria. The WYWA functionality can also group the events into categories (e.g., news stories, Email messages, etc.) and present the events to the user in the context of these categories. FIG. 4, to be discussed in turn, shows one exemplary user interface presentation that can be provided by the WYWA functionality.

FIG. 1 conceptually denotes the electronic environment 104 as an ellipse. As noted above, the term “electronic environment” can correspond to applications run at a local device or applications run in a networked (online) environment (which may involve the invocation of application software stored at the local device and/or head-end infrastructure). In one case, ceasing and resuming interaction with an electronic environment refer to engaging in and disengaging from interaction with a local electronic device, respectively. In another case, ceasing and resuming interaction with an electronic environment refer to engaging in and disengaging from one or more applications hosted by the local electronic device, respectively. In another case, ceasing and resuming interaction with an electronic environment refer to engaging in and disengaging from a network in general (such as a local or wide area network, e.g., the Internet as a whole), respectively. In another case, a ceasing and resuming interaction with an electronic environment refer to engaging in and disengaging from one or more applications supported by a network, respectively. Thus, the term “electronic environment” has broad connotation; an environment may represent a service or plural services provided by a single commercial entity deployed at any location or locations, or may represent a loose aggregation of different services provided by different commercial entities deployed at any location or locations.

Finally, FIG. 1 shows various user devices 106, illustrating the fact that the WYWA concept can be applied to many different kinds of devices and technical platforms, including any kind of stationary computer (e.g., personal computer workstation), any kind of portable computer (e.g., laptop computer), a suitably equipped mobile phone, a personal digital assistant device (PDA), any kind of tablet device, any kind of game console device (such as Microsoft Corporation's Xbox™ game console), and so forth.

A.2. Exemplary While You Were Away (WYWA) Functionality

FIG. 2 shows an overview of WYWA functionality 200. FIG. 2 depicts the components of the WYWA functionality 200 as an integrated unit to facilitate explanation. However, as will be described shortly with respect to FIG. 3, the components of the WYWA functionality 200 can be implemented in different ways. In a first case, the WYWA functionality 200 can be implemented entirely at a client level within the devices used by individual users. In a second case, the WYWA functionality 200 can be implemented entirely within head-end infrastructure (such as within one or more head-end server machines). In a third case, the WYWA 200 can be implemented by a distribution of components at both the client devices and the head-end infrastructure. FIG. 2 thus serves mainly as an explanation of the functions performed by the WYWA functionality 200 and the interrelation of those functions, which may map to different physical implements in different ways.

One component of the WYWA functionality 200 is a cessation/resumption detection module 202. As the name suggests, this module 202 detects when a user has ceased or resumed interaction with an electronic environment. This feature can be implemented differently depending on the electronic environment involved. In a local environment, -the module 202 can determine whether the user has ceased/resumed interaction with a device or only an application (or applications) hosted by the device. In a network environment, the module 202 can determine whether the user has ceased/resumed interaction with a network in general (such as the Internet, an Intranet, etc.), or just a particular service (or services) offered by the network.

As explained, the terms “ceasing” and “resuming” have broad connotation. In one case, ceasing/resuming can be detected on the basis of express commands entered by the user. In another case, ceasing/resuming can be detected on the basis of other activity by the user (or lack of activity), e.g., based on the user's interaction (or lack of interaction) with the electronic environment via keyboard, mouse, voice recognition input, etc. For example, the user can be considered to have ceased interaction with the electronic environment when the user fails to enter any input into the electronic environment for a predetermined period of time, or when the user renders a first application program idle by activating a second application program, and so forth.

Consider, for example, the case where the electronic environment corresponds to a network with which the user can log onto and off of. Different mechanisms can be used to determine whether the user has logged onto a network in general. In one technique, a single password paradigm can be used to log the user onto network services. This sign-on event can be used to detect the user's logon to the network in general. For example, Microsoft Corporation's Passport functionality can be adapted to achieve this end. In other cases, plural vendors of network provider services may contractually agree to share logon and logoff event information to a central “clearinghouse” for the purposes of accommodating the WYWA functionality 200. Still other implementations of module 202 are possible.

An event detection module 204 is triggered when the user ceases interaction with the electronic environment. This module 204 then commences detecting events which occur within the electronic environment. Namely, the electronic environment may include a vast number of different sources 206. In one case, the sources 206 may be affiliated with a single commercial entity. In another case, the sources 206 may be affiliated with different commercial entities. The detection module 204 can be configured to detect events associated with these different sources 206, such as by monitoring the network addresses of these different sources 206, or otherwise intercepting communication forwarded to the user by these sources 206, etc.

A preference module 208 allows an administrator and/or user to enter preference information for storage in a preference store 210. The preference information can be used to govern the operation of the WYWA functionality 200. For instance, a first class of preference information can be used to select the kinds of events that the event detection module 204 should detect and retain. For example, the administrator or the user may configure the WYWA functionality 200 to detect events associated with certain news sources, Email sources, and so forth, while ignoring other sources. A second class of preference information can be used to determine how the thus collected events are organized and presented to the user. For instance, based on the preference information, the events can be organized based on chronological order of occurrence, or on some other basis. Also, based on the preference information, the events can be grouped into different specified categories. Still other classes of preference information can be defined to govern the operation of the WYWA functionality 200.

Accordingly, the event detection module 204 can use the setup information stored in the preference information store 210 to determine which of the event sources 206 it should monitor and extract event information.

In another implementation, the event detection module 204 can apply analysis to dynamically determine which event sources 206 it should monitor. For instance, the WYWA functionality 200 can apply analysis to determine the evolving interests of a user, e.g., based on the frequency at which the user utilizes certain network services. The event detection module 204 can use this knowledge to capture events from the sources 206 in which the user currently expresses interest. The analysis can also take account for other factors, such as the user's biographical characteristics, prior purchases, and so forth. The analysis can also leverage knowledge gained regarding the user's interests for various cross-selling and up-selling opportunities, e.g., by collecting and presenting events from sources 206 that the user is likely to be interested in based on the user's interest in related or complementary sources. Still other variations along these lines are envisioned. In any of these cases, the user's online activity can be determined by monitoring the network sites that the user visits. Different modules can collect this information. In one case, a browser-type service or like service working in conjunction with the event detection module 204 can collect this information. In another case, cooperating sites can furnish the event detection module 204 with “hit” information indicating user interest in these sites.

An event storage module 212 stores the filtered events in an event store 214 from the time that the user has ceased interaction with the electronic environment until the time that the user resumes interaction with electronic environment. Where the WYWA functionality 200 is implemented by a network environment, this functionality 200 can be implemented as a head-end event store 214 that records the events associated with a plurality of users. A head-end implementation allows the WYWA functionality 200 to be accessed in roaming scenarios by different access devices. In any environment, it is also possible to individually implement the event store 214 by respective local client devices, in which case each event store 214 can record events that are specific to a particular respective user. In any case, the event store 214 can record events in various ways, such as by providing a network address associated with each event (e.g., corresponding to the location of a story at a news site, etc.), storing some other kind of link to the event, storing metadata associated with the event (e.g., the title of the event), and/or storing the content of the event itself in its entirety.

An event organization module 216 organizes the stored events in the event store 214. For instance, the event organization module 216 can organize the events based on various criteria, such as the time of occurrence of the events, and so forth. The event organization module 216 can also group the events into categories in the manner described above. As shown in FIG. 2, the event organization module 216 can perform its organization of events based on setup information provided by the preference information store 210. Alternatively, or in addition, the event organization module 216 can perform dynamic analysis to determine how best to arrange the events. For instance, the WYWA functionality 200 may determine that the user considers a particular topic more interesting that another, e.g., based on the detected frequency at which the user interacts with a certain event source. Based on this knowledge, the event organization module 216 can position this topic first in the user interface presentation (e.g., at the top of a top-down list of topics).

Finally, an event retrieval module 218 is responsible for presenting the organized events to the user in the form of a user interface presentation. The event retrieval module 218 is coupled to the cessation/resumption detection module 202. The event retrieval module 218 is particularly triggered to provide the event information to the user when the user resumes interaction with the electronic enviromnent following the user's absence from the environment.

FIG. 3 shows one exemplary system 300 that can be used to implement the WYWA functionality 200 of FIG. 2. The system 300 includes a collection of devices (302, 304, . . . 306) coupled together via a coupling mechanism 308. The system can provide optional head-end infrastructure 310 for interacting with the devices (302, 304, . . . 306) via the coupling mechanism 308.

The coupling mechanism 308 can comprise any mechanism or combination of mechanisms for coupling the components of the system 300 together. For instance, the coupling mechanism 306 can include any kind of network (or combination of networks), such as a wide area network (e.g., the Internet), an intranet, Digital Subscriber Line (DSL) network infrastructure, point-to-point coupling infrastructure, and so on. The coupling mechanism 308 can use or involve any kind of protocol or combination of protocols, such as the Internet Protocol (IP), the Transmission Control Protocol (TCP), the User Datagram Protocol (UDP), the HyperText Transfer Protocol (HTTP), the Simple Object Access Protocol (SOAP), and many potential others. In the case where one or more digital networks are used to disseminate information, the coupling mechanism 308 can include various hardwired and/or wireless links, routers, gateways, name servers, and so on (not shown).

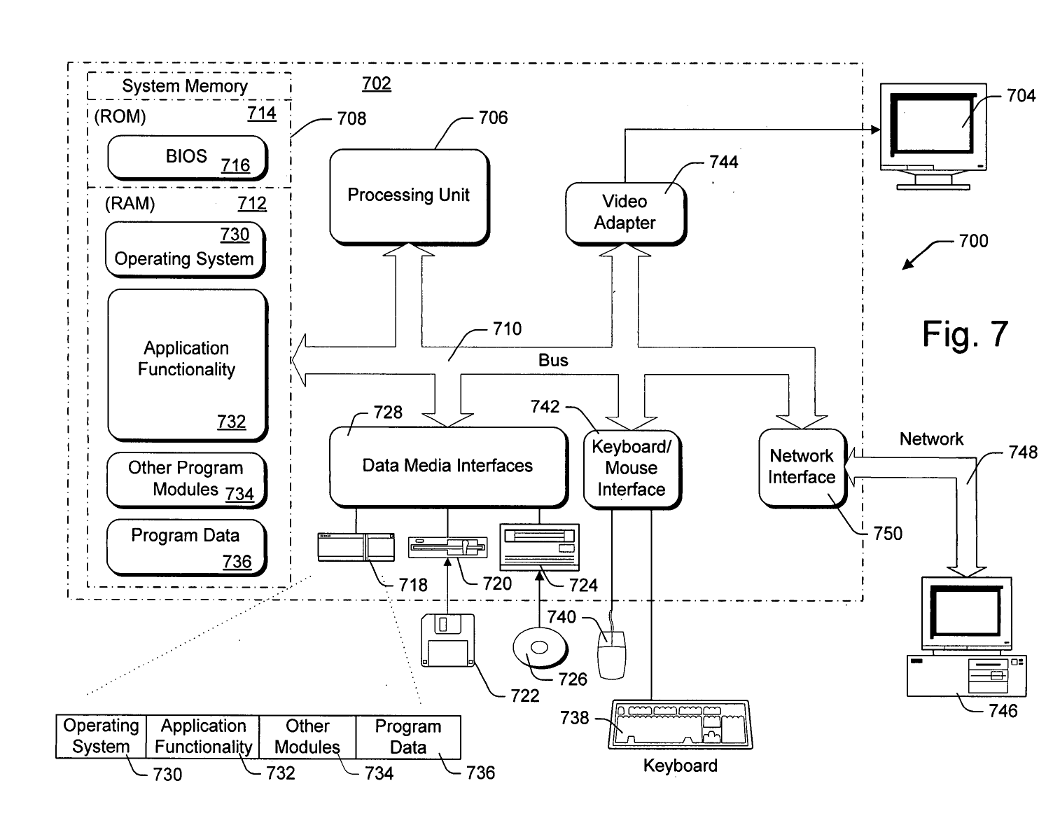

The head-end infrastructure 310 can comprise any combination of equipment for providing services to the client devices (302, 304, . . . 306). For instance, the head-end infrastructure 310 can comprise one or more server machines (e.g., a server farm) for providing services to the devices (302, 304,. . . 306), as well as one or more databases for storing announcements, identity information, and so forth. The components of the head-end infrastructure 310 can be located at a single site or distributed over plural sites. Where the head-end infrastructure 310 is implemented by server machines, FIG. 7, to be discussed in turn, provides one exemplary computer environment for implementing each of those machines.

Each client device (302, 304, . . . 306) can include any kind of equipment for interacting with other devices and/or the head-end infrastructure 310. In one exemplary case, the client devices (302, 304, . . . 306) can correspond to any of the devices 106 shown in FIG. 1, such as personal computer devices, personal digital assistant (PDA) devices, intelligent mobile phone devices, any kind of transportable or wearable computer device, any kind of game console device (such as Microsoft Corporation's Xbox™ game consoles), and so on. Where the devices (302, 304, . . . 306) are implemented by some kind of computer devices, FIG. 7, to be discussed in turn, provides one exemplary computer environment for implementing each of those machines.

FIG. 3 shows that representative client module A (302) includes a processing unit 312 coupled to a presentation unit 314. The processing unit 312 comprises any data processing functionality for performing various ascribed tasks, while the presentation unit 314 provides any kind of output mechanism by which a user can interact with the processing unit 312. The presentation unit 314 can provide visual output, audio output, tactile output, any combination of such outputs, and so forth.

FIG. 3 shows that the WYWA functionality 200 (introduced and described in the context of FIG. 2) can be implemented entirely at the peer client level by individual devices (302, 304, . . . 306). Or the WYWA functionality 200 can be implemented entirely at the head-end level by the head-end infrastructure 310 (e.g., as a “Web” application). Or the WYWA functionality 200 can be implemented by a combination of functionality provided by both the device level and head-end level. For example, in the last-mentioned scenario, the devices (302, 304,. . . 306) can store software that performs a subset of prescribed tasks of the WYWA functionality 200, and the head-end infrastructure 310 can store software that performs another subset of prescribed tasks. The various data stores shown in FIG. 2 (e.g., 210, 214) can be stored at the device level, the head-end level, or by a distributed combination of the device level and the head-end level.

As to business models, in one exemplary implementation, users can access the WYWA functionality 200 free of charge. In another exemplary implementation, only subscribing users can access the WYWA functionality 200 upon paying a prescribed fee. More precisely, in either the first case or the second case, the WYWA functionality 200 can be “piggybacked” on top of another service to provide an introductory user interface presentation to the service (such as, to give one non-limiting example, Microsoft Corporation's MSN service, or an instant messaging IM service, and so forth).

B. Exemplary User Interface Presentations (FIG. 4)

As indicated in FIG. 3, any of the user devices (302, 304, . . . 306) can provide a user interface 316 that can be used to display the user interface presentation provided by the WYWA functionality 200. The user interface 316 can be used to present user interface presentations based on logic stored at the device level, at the head-end level (e.g., as a Web application), or at a combination of the device level and head-end level. The user interface presentations can comprise graphical and/or textual content displayed on the presentation unit 314. Users can interface with this content through various input mechanisms, such as keyboard, mouse device, touch screen, and so forth. Alternatively, the user interface can be implemented in whole or in part by audio mechanisms, e.g., by verbally announcing events to the users that have occurred in their absence when the users resume interaction with the electronic environment.

FIG. 4 provides one exemplary user interface presentation 400 that can be used to provide the WYWA information collected by the WYWA functionality 200. The reader will appreciate that the style, organization and content of this user interface presentation 400 can be changed to suit different technical and business environments (or to suit mere stylistic preferences). For instance, where the WYWA functionality 200 is applied to a wireless network environment, the enabling system may opt to reduce the amount of information in the user interface presentations to accommodate the display of this information on smaller devices (e.g., mobile phones).

The WYWA user interface presentation 400 includes various fields that will be described in turn. In this specific example, assume that a user was logged onto an electronic environment (e.g., an online network service) at 6:00 AM upon. waking, and then promptly logs off. Then assume the user logged back on upon arriving at work at 9:30 A.M. In this exemplary scenario, the WYWA functionality 200 serves to alert the user to events which have transpired in different categories during the interval between 6:00 A.M. and 9:30 A.M. Further note, in this specific scenario, that the WYWA functionality 200 “floats” or “roams” with the user, no matter where the user accesses the WYWA functionality 200.

A first field 402 of the presentation 400 provides the events that have transpired while the user, Alice, was “away” from the electronic environment. In one case (not illustrated), this field 402 can display a list of events arranged in chronological order from most recent to least recent (but still occurring within the interval of time that the user was away from the electronic environment). In this case, the events from different categories can be mixed in together in whatever order they were received. In another implementation, which corresponds to the illustrated case of FIG. 4, the field 402 can organize the events into categories, and then display the events in the context of these categories. In the entirely exemplary and illustrative case of FIG. 4, the WYWA functionality 200 has grouped detected messages into an Email category, an offline instant messenger (IM) category, a world news category, a national news category, an online real estate category, an online dating category, a finance-related category, a virus alert category, and so forth. Accordingly, with a quick scan of this page upon return to the environment, the user can gain a very thorough update on a number of topics which concern the user.

In one case, each of the categories can present all of their entries within a single user interface pane. In this case, the user can scroll down to view the complete collection of categories (if the information cannot fit on one screen). In another case, the user interface presentation 400 can present only some of the entries for each category (such as the two most recent entries, as in the case of FIG. 4). The user can then access additional entries in any category by clicking on the “more” command link associated with the category.

In one case, the user interface presentation 400 can be configured such that the user can activate any individual event to access more information regarding the event (if such information is available). This can be implemented by configuring the event descriptions as hypertext links. Namely, for example, the activation of an entry in the Email notification category can prompt the WYWA functionality 200 to activate an Email application. Activation of an entry within the offline messenger category can prompt the WYWA functionality 200 to activate an IM session with a corresponding user (if that user happens to be online) or to generate an offline response (if that user is not online). Activation of an entry within any news type category can prompt the WYWA functionality 200 to access the site that provides the full content of the news type entry. In another case, the provider of the interface presentation 400 may want to disable interactive content within the interface presentation 400 so that it does not become too complicated or distracting.

A sort selection 404 can be used to allow the user to dynamically change the ordering scheme used to present the events. This selection 404 can be used, for instance, to sort the entries in chronological order from most recent to least recent, from least recent to most recent, and so forth. This section 404 can also be used to modify the order in which the categories are presented.

The user interface presentation 400 also preferably includes other sections not directly related to the WYWA event information. This feature is potentially valuable because it provides the user with an integrated snapshot of a large amount of information that is likely to interest the user. Further, a provider may wish to supply such supplemental information in association with the WYWA information to piggyback off of the engaging nature of the WYWA event information; namely, because the user may be very interested in the WYWA event information, they may be more actively engaged in supplemental information placed in proximity to this WYWA information.

One supplemental field 406 of information pertains to information that is tailored to the geographic area at which the user is using his or her device. This can be implemented by providing information associated with the zip code of the user (which the user may manually supply in advance, or which may be inferred based on the device's address, the user's telephone number, or other identity information). On this same theme, further note that the WYWA functionality 200 personalizes the user interface presentation 400 by displaying a greeting which contains the user's name (“Welcome Back Alice!”). Further user-specific or location-specific information can be presented of a similar nature.

Another supplemental field 408 allows the user to perform a search, such as a local search within a particular network application, or a global search over the entire web.

Another supplemental field 410 can be used to display information regarding a particular network service. For instance, where a certain commercial entity sponsors the WYWA functionality 200, it may use this space 410 to provide updates or enticements regarding new features that it offers.

Another supplemental field 412 can be used to display advertising information to the user. The advertising information is preferably targeted to the biographical or behavioral characteristics of the user, so that it will be more likely to interest the user. The characteristics of the user can be determined based on information that the user manually inputs in advance. Alternatively, or in addition, the characteristics of the user can be inferred by automated analysis based on, for example, patterns in the user's online activity (as gleaned from, for example, the sites that the user visits and the online purchases that the user makes).

To repeat, the layout and content of the user interface presentation 400 is exemplary. Other user interface presentations may include additional fields, may omit certain fields shown in FIG. 4, may adopt different styles and organizations of information, and so on.

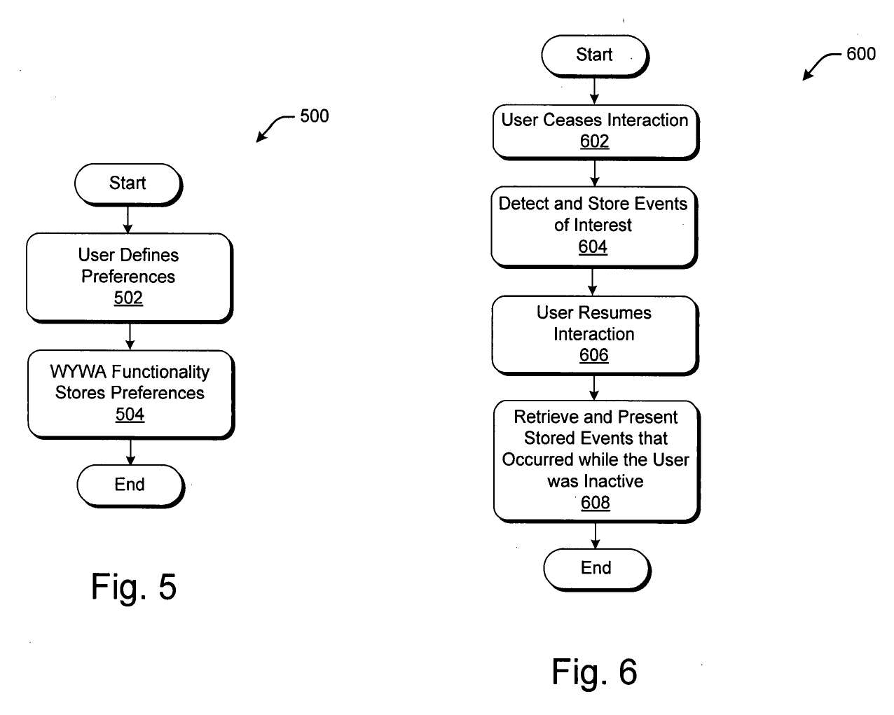

C. Exemplary Method of Operation (FIGS. 5 and 6)

FIGS. 5 and 6 together describe the operation of the WYWA functionality 200 in flow chart form. To facilitate discussion, certain operations are described as constituting distinct steps performed in a certain order. Such implementations are exemplary and non-limiting. Certain steps described herein can be grouped together and performed in a single operation, and certain steps can be performed in an order that differs from the order employed in the examples set forth in this disclosure. As the functions performed by the WYWA functionality 200 have been fully explained in prior sections, this section will serve primarily as a review of those functions.

The procedure 500 shown in FIG. 5 describes how the WYWA functionality 200 captures preference information. In step 502, the administrator or user inputs preference information (such as the types of sources that should be monitored, the ranking of those sources, and so forth). In another case, the WYWA functionality 200 can infer such preference information on the basis of patterns in the user's behavior, and so on. In step 504, the WYWA functionality 200 stores these preferences.

The procedure 600 shown in FIG. 6 describes how the WYWA functionality 200 supplies the WYWA user interface presentation to the user. In step 602, the user ceases interaction with an electronic environment. In step 604, the WYWA functionality 200 commences detecting events of interest based on the preference information collected in procedure 500. In step 606, the user resumes interaction with the electronic environment. In step 608, the WYWA functionality 200 organizes the events in a prescribed order (and optionally in prescribed categories) and presents these events to the user.

D. Exemplary Computer Environment (FIG. 7)

In one exemplary implementation, certain aspects of the WYWA functionality 200 can be implemented as computer code executed by one or more computer devices. For example, server machines associated with the head-end infrastructure 310 can be implemented by one or more computer devices. Also, the client devices (302, 304,. . . 306) can be implemented by computer devices. In this case, FIG. 6 provides information regarding an exemplary computer environment 700 that can be used to implement each such computer devices.

The computing environment 700 includes a general purpose or server type computer 702 and a display device 704. However, the computing environment 700 can include other kinds of computing equipment. For example, although not shown, the computer environment 700 can include hand-held or laptop devices, set top boxes, game consoles, mainframe computers, etc. Further, FIG. 7 shows elements of the computer environment 700 grouped together to facilitate discussion. However, the computing environment 700 can employ a distributed processing configuration. In a distributed computing environment, computing resources can be physically dispersed throughout the environment.

Exemplary computer 702 includes one or more processors or processing units 706, a system memory 708, and a bus 710. The bus 710 connects various system components together. For instance, the bus 710 connects the processor 706 to the system memory 708. The bus 710 can be implemented using any kind of bus structure or combination of bus structures, including a memory bus or memory controller, a peripheral bus, an accelerated graphics port, and a processor or local bus using any of a variety of bus architectures.

Computer 702 can also include a variety of computer readable media, including a variety of types of volatile and non-volatile media, each of which can be removable or non-removable. For example, system memory 708 includes computer readable media in the form of volatile memory, such as random access memory (RAM) 712, and non-volatile memory, such as read only memory (ROM) 714. ROM 714 includes an input/output system (BIOS) 716 that contains the basic routines that help to transfer information between elements within computer 702, such as during start-up. RAM 712 typically contains data and/or program modules in a form that can be quickly accessed by processing unit 706.

Other kinds of computer storage media include a hard disk drive 718 for reading from and writing to a non-removable, non-volatile magnetic media, a magnetic disk drive 720 for reading from and writing to a removable, non-volatile magnetic disk 722 (e.g., a “floppy disk”), and an optical disk drive 724 for reading from and/or writing to a removable, non-volatile optical disk 726 such as a CD-ROM, DVD-ROM, or other optical media. The hard disk drive 718, magnetic disk drive 720, and optical disk drive 724 are each connected to the system bus 710 by one or more data media interfaces 728. Alternatively, the hard disk drive 718, magnetic disk drive 720, and optical disk drive 724 can be connected to the system bus 710 by a SCSI interface (not shown), or other coupling mechanism. Although not shown, the computer 702 can include other types of computer readable media, such as magnetic cassettes or other magnetic storage devices, flash memory cards, CD-ROM, digital versatile disks (DVD) or other optical storage, electrically erasable programmable read-only memory (EEPROM), etc.

Generally, the above-identified computer readable media provide non-volatile storage of computer readable instructions, data structures, program modules, and other data for use by computer 702. For instance, the readable media can store the operating system 730, application-specific functionality 732 (including functionality for implementing aspects WYWA functionality 200), other program modules 734, and program data 736.

The computer environment 700 can include a variety of input devices. For instance, the computer environment 700 includes the keyboard 738 and a pointing device 740 (e.g., a “mouse”) for entering commands and information into computer 702. The computer environment 700 can include other input devices (not illustrated), such as a microphone, joystick, game pad, satellite dish, serial port, scanner, card reading devices, digital or video camera, etc. Input/output interfaces 742 couple the input devices to the processing unit 706. More generally, input devices can be coupled to the computer 702 through any kind of interface and bus structures, such as a parallel port, serial port, game port, universal serial bus (USB) port, etc.

The computer environment 700 also includes the display device 704. A video adapter 744 couples the display device 704 to the bus 710. In addition to the display device 704, the computer environment 700 can include other output peripheral devices, such as speakers (not shown), a printer (not shown), etc.

Computer 702 operates in a networked environment using logical connections to one or more remote computers, such as a remote computing device 746. The remote computing device 746 can comprise any kind of computer equipment, including a general purpose personal computer, portable computer, a server, etc. Remote computing device 746 can include all of the features discussed above with respect to computer 702, or some subset thereof

Any type of network 748 can be used to couple the computer 702 with remote computing device 746, such as the WAN 402 of FIG. 4, a LAN, etc. The computer 702 couples to the network 748 via network interface 750 (e.g., the interface 416 shown in FIG. 4), which can utilize broadband connectivity, modem connectivity, DSL connectivity, or other connection strategy. Although not illustrated, the computing environment 700 can provide wireless communication functionality for connecting computer 702 with remote computing device 746 (e.g., via modulated radio signals, modulated infrared signals, etc.).

Although the invention has been described in language specific to structural features and/or methodological acts, it is to be understood that the invention defined in the appended claims is not necessarily limited to the specific features or acts described. Rather, the specific features and acts are disclosed as exemplary forms of implementing the claimed invention.

What is claimed is:

1. A method for alerting a user to events, comprising:
detecting when the user ceases interaction with an electronic environment;
detecting and retaining events which transpire after the user ceases interaction with the electronic environment to provide detected events, providing that the events meet at least one criterion;
detecting when the user resumes interaction with the electronic environment; and
alerting the user, upon their resumption of interaction, to the detected events which have transpired between the times that the user ceases interaction with the electronic environment and resumes interaction with the electronic environment.

2. The method of claim 1, wherein the electronic environment comprises at least one application implemented over a network.

3. The method of claim 1, wherein the electronic environment comprises at least one application implemented by a standalone electronic device.

4. The method of claim 1, wherein the detecting of when the user ceases interaction with the electronic environment comprises detecting when the user enters a command to cease interaction with the electronic environment or when the user otherwise becomes inactive with respect to the electronic environment, and the detecting of when the user resumes interaction with the electronic environment comprises detecting when the user enters a command to resume interaction with the electronic environment or otherwise again becomes active with respect to the electronic environment.

5. The method of claim 1, wherein the events which transpire after the user ceases interaction with the electronic environment comprise at least one of:
a posting of information by a network site;
a receipt of an Email message; and/or
a receipt of an offline instant messenger message.

6. The method of claim 1, wherein the events which transpire after the user ceases interaction with the electronic environment emanate from plural sources.

7. The method of claim 6, wherein the plural sources comprise plural network-enabled electronic applications.

8. The method of claim 1, wherein said at least one criterion comprises filtering information that defines types of events that should be retained.

9. The method of claim 1, further comprising organizing the detected events into an order based on at least one ordering criterion.

10. The method of claim 9, wherein the ordering criterion comprises the time of occurrence of the retained events.

11. The method of claim 1, further comprising grouping the detected events into plural groups, and the alerting comprises presenting the detected events to the user in the context of the plural groups.

12. The method of claim 1, wherein the alerting comprises presenting the detected events to the user in the form of a user interface panel when the user resumes interaction with the electronic environment.

13. The method of claim 12, wherein a first part of the user interface panel presents the detected events.

14. The method of claim 13, wherein another part of the user interface panel presents information which is tailored to the geographic location of the user and/or the identity of the user.

15. The method of claim 13, wherein another part of the user interface panel presents advertising information which is tailored to the characteristics of the user.

16. The method of claim 13, wherein another part of the user interface panel presents application-related features provided by an entity that sponsors the user interface panel.

17. One or more machine-readable media containing machine readable instructions for implementing the method of claim 1.

18. Logic functionality configured to alert a user to events, comprising:
logic configured to detect when the user ceases interaction with an electronic environment;
logic configured to detect and retain events which transpire after the user ceases interaction with the electronic environment to provided detected events, providing that the events meet at least one criterion;
logic configured to detect when the user resumes interaction with the electronic environment; and
logic configured to alert the user, upon their resumption of interaction, to the detected events which have transpired between the times that the user ceases interaction with the electronic environment and resumes interaction with the electronic environment.

19. One or more machine-readable media containing machine readable instructions for implementing the logic functionality of claim 18.

20. A method of displaying events to a user, comprising:
determining events which have transpired while the user was inactive with respect to an electronic environment to provide detected events;
displaying the detected events to the user in a user interface panel,
wherein the user interface panel includes:
a first part that presents the detected events;
a second part that present information which is tailored to the geographic location of the user and/or the identity of the user;
a third part that presents advertising information which is tailored to the characteristics of the user; and
a fourth part that presents application-related features provided by an entity that sponsors the user interface panel.
